(19) United States
(12) Patent Application Publication
(10) Pub. No.: US 2010/0044191 A1
(43) Pub. Date: Feb. 25, 2010

(54) MODULE FOR A CONVEYOR MAT, MODULAR CONVEYOR MAT AND CONVEYOR

(75) Inventor: Michael Van Rees, Rhoon (NL)

Correspondence Address: QUARLES & BRADY LLP, 411 E. WISCONSIN AVENUE, SUITE 2040, MILWAUKEE, WI, 53202-4497, US

(73) Assignee: REXNORD FLATTOP EUROPE B.V., GV'S-gravenzande (NL)

(21) Appl. No.: 11/913,237

(22) PCT Filed: May 1, 2006
(86) PCT No.: PCT/NL2006/000232

§ 371 Date: Nov. 11, 2009

(30) Foreign Application Priority Data
May 4, 2005 (NL) 1028964

(51) Int. Cl. B65G 17/08

(52) U.S. Cl. 198/853

(57) ABSTRACT

A module for a conveyor mat, comprising a body part (3) which is provided, on front and rear sides extending, during use, transversely to a conveying direction, with staggered rows of hinge loops (6), spaced apart by intermediate spaces, transversely to the conveying direction, with hinge holes extending transversely to the conveying direction in a manner such that front and rear sides of successive modules can be coupled with the aid of a hinge pin which extends transversely to the conveying direction, with the hinge loops (6) interlocking. The hinge loops (6) extend between, on the one side, outer faces situated on front or rear sides of the module and, on the other side, inside faces situated closer to the middle of the module. The outer faces (14) are provided with outer driving faces (14A) for cooperation with teeth (24) of a drive wheel (15) of a first type and the inner faces (13) are provided with inner driving faces (13A) for cooperation with the teeth (26) of a drive wheel (16) of a different type.

The invention relates to modular conveyor mats and in particular to modules for modular plastic conveyor mats formed by rows of plastic mat modules hingedly coupled by means of hinge pins.

As they are light-weight, do not corrode and are relatively easy to clean, modular plastic conveyor mats are widely used, inter alia when conveying food products. As a rule, modular plastic conveyor mats are built up from mold-formed, plastic, modular connecting elements, called mat modules, which can be placed side by side in rows with the desired width. Here, rows of spaced apart hinge loops extend along sides of the modules lying opposite each other. The rows of hinge loops are provided with aligned hinge holes for including a hinge pin. The hinge loops along one side of a row of modules are then connected to the hinge loops of a side of an adjoining row of modules, like, for instance, the pattern of interlacing hands. As a rule, a hinge pin included in the aligned hinge holes forms a hinge joint between adjoining rows. In general, rows of modules are interconnected to form an endless conveyor mat which can run on return wheels.

As a rule, for driving the mat, drive wheels are provided which engage on driving locations of the modules. A problem that occurs with modular mats is providing driving locations on the modules that limit the usability of the modules as little as possible. In particular, it is difficult to provide a driving location that guarantees a good power transmission, can be cleaned well and enables the conveyor mat formed by the modules to cooperate with already existing conveyor paths and driving provisions included therein. To reduce this problem, the invention provides a module according to claim 1.

What can be achieved by providing staggered rows of hinge loops lying opposite each other with hinge holes situated eccentrically between inner and outer driving faces is, that the modules can be driven on two locations on the hinge loops, so that a good power transmission can be combined with a good cleanability of the module and a good deployability of the module. The outer driving faces can, in particular, be optimized for cooperation with a first type of drive wheel, whose teeth can be received sideways between the side surfaces of two adjoining hinge loops of a successive module, in particular the teeth of a sprocket wheel with six to twelve teeth. The inner driving faces can be optimized for cooperation with teeth of another type of drive wheel, for instance a drive wheel which cooperates with the inner driving faces of several hinge loops successive transverse to the conveying direction, and/or a drive wheel with, for instance, twelve or more teeth, in particular a sprocket wheel borne by the jacket of a drum motor.

The invention also relates to a modular conveyor mat.

Further advantageous embodiments of the invention are represented in the subclaims and will be elucidated on the basis of an exemplary embodiment represented in a drawing. In the drawing:

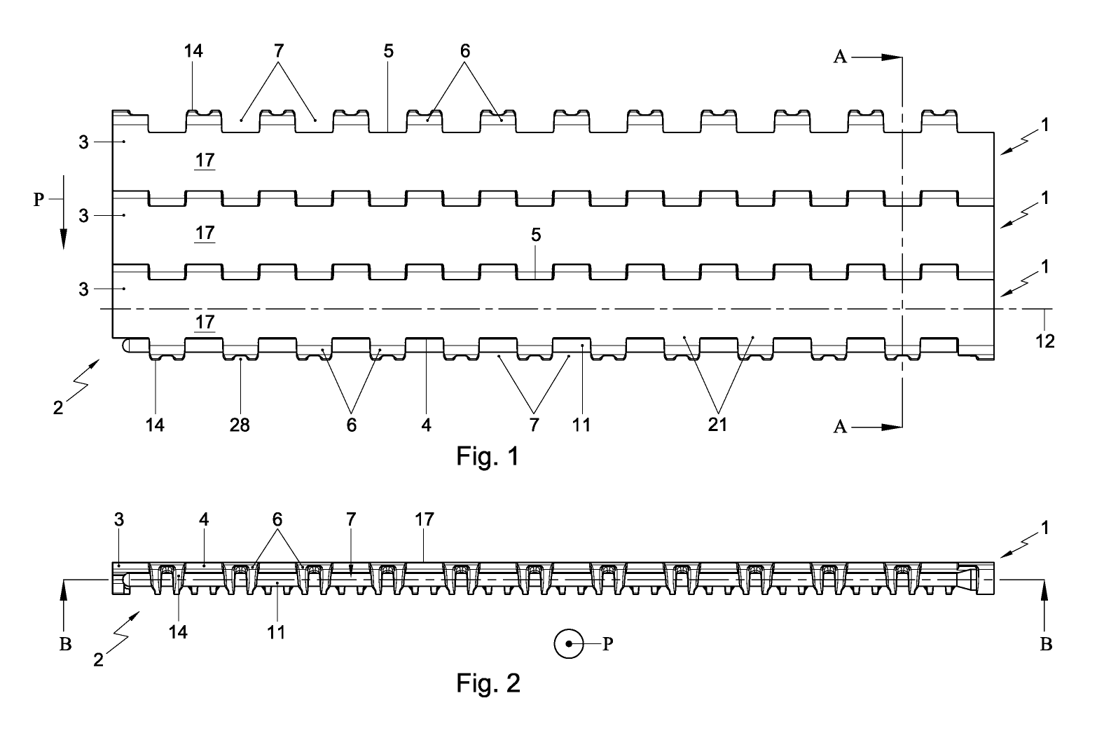

FIG. 1 shows a schematic top plan view of a conveyor mat according to the invention;

FIG. 2 shows a schematic front view of the conveyor mat of FIG. 1;

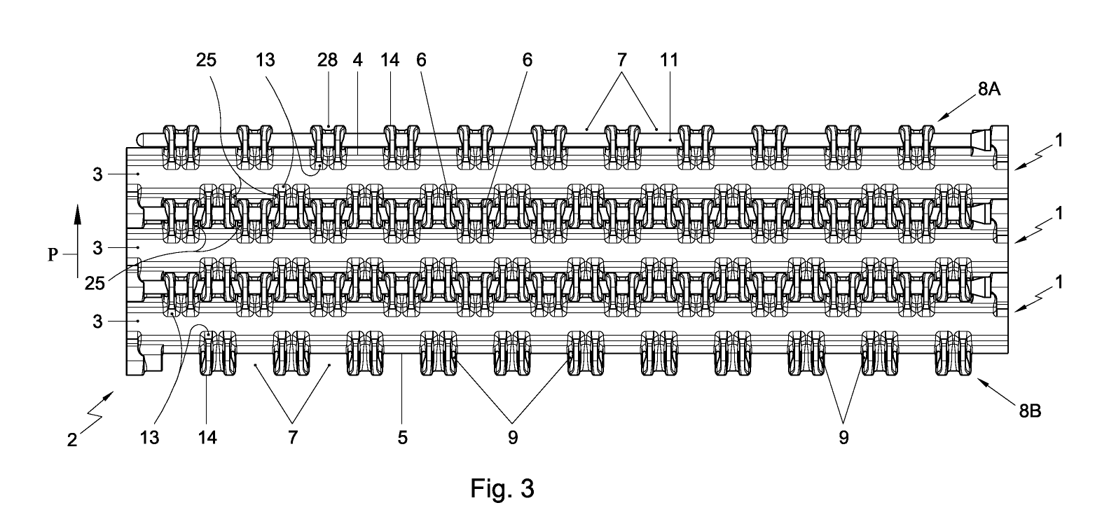

FIG. 3 shows a schematic bottom view of the conveyor mat of FIG. 1;

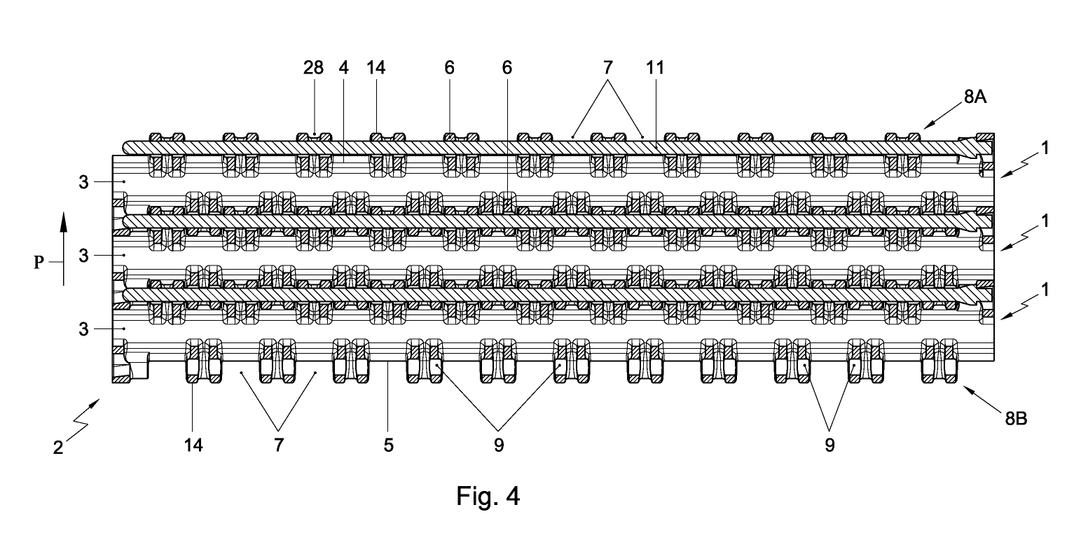

FIG. 4 shows a schematic bottom view of the conveyor mat of FIG. 1, cross-sectioned along the line B-B in FIG. 2;

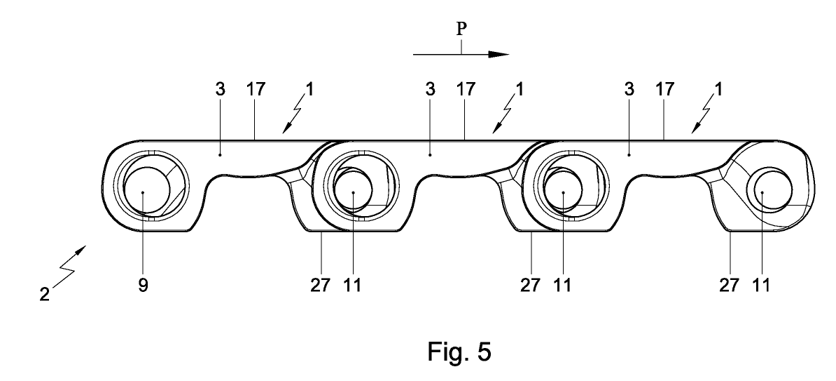

FIG. 5 shows a schematic side view of the conveyor mat of FIG. 1;

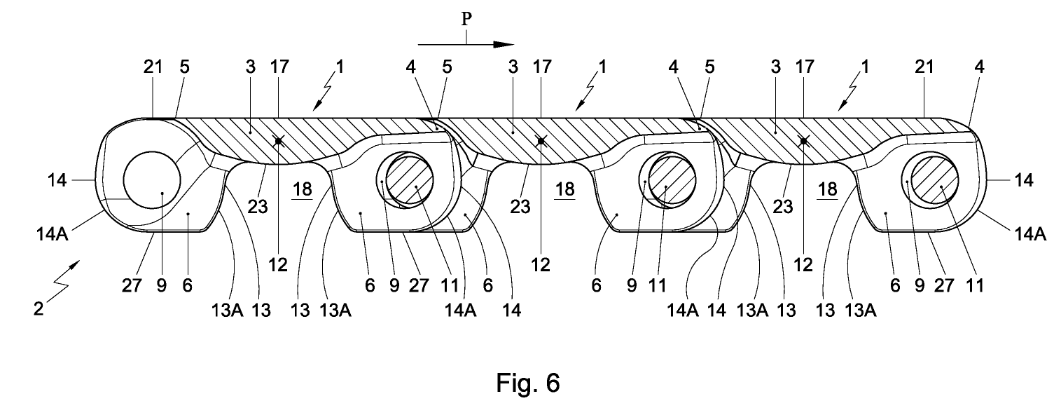

FIG. 6 shows a schematic cross-section of the mat of FIG. 1 along the line A-A in FIG. 1;

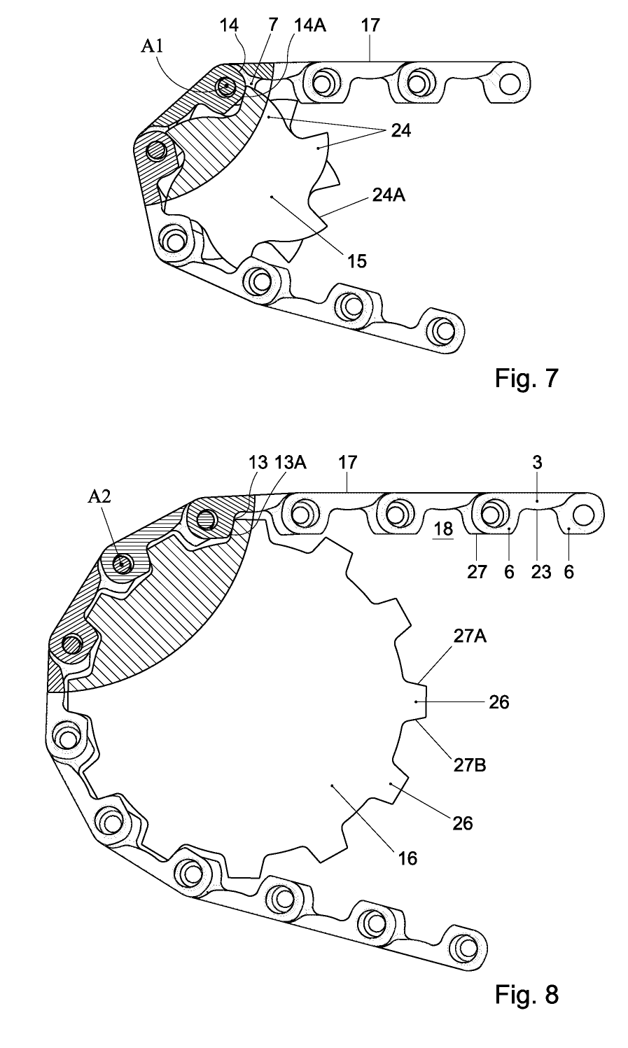

FIG. 7 shows a schematic side view of a detail of a first type of drive wheel that cooperates with an outer driving face of the module; and

FIG. 8 shows a schematic side view, in detail, of teeth of a second type of drive wheel that cooperates with inner driving faces of the modules.

It is noted that the Figures are merely schematic representations of a preferred embodiment of the invention which is described by way of non-limitative exemplary embodiment. In the Figures, identical or corresponding parts are represented with the same reference numerals.

With reference to FIGS. 1-6, a module 1 is shown which is included in a part of a conveyor mat 2. The module 1 comprises a body part 3 which is provided, on a front side 4 and rear side 5 extending, during use, transversely to a conveying direction indicated with arrow P, with rows of hinge loops 6. The hinge loops 6 are spaced apart by intermediate spaces 7, transversely to the conveying direction P. As indicated in FIGS. 3 and 4, the hinge loops 6 of the front row 8A are staggered transversely to the conveying direction relative to the hinge loops 6 of the back row 8B.

The hinge loops 6 are provided with hinge holes 9, extending transverse to the conveying direction P, which are aligned per row.

The front sides 4 and the rear sides 5 of the successive modules are coupled by means of a hinge pin 11 extending transversely to the conveying direction P. The hinge loops 6 then interlock like the fingers of two interlacing hands.

The hinge loops 6 extend from inner faces 13 situated closer to the center line 12 of the module 1 represented in FIG. 6, to outer faces 14 situated further away from the center line and located on the front side 4 or the rear side 5, respectively, of the module 1.

Here, the outer faces 14 are situated closer to the hinge loops 9 than the inner faces 13.

The inner faces 13 are provided with inner driving faces 13a for cooperation with the teeth of a first type of drive wheel 15. The outer faces 14 are provided with outer driving faces 14a for cooperation with the teeth of a drive wheel 16 of a second type.

The inner driving faces 13a and the outer driving faces 14a have a substantially curved configuration: the driving faces are curved relative to an axis of curvature A1 or A2, respectively, extending substantially transversely to the conveying direction. This axis of curvature is formed by the central axis of the hinge pin 11 when this abuts against the edge of the hinge loop 6 adjoining the driving face.

The curvature of the outer driving faces is stronger than the curvature of the inner driving faces: the radius of curvature R1 of the inner driving faces 13a is greater than the radius of curvature R2 of the outer driving faces 14a.

The body part 3 is substantially of sheet-shaped design. The hinge loops 6 extend downward relative to the conveying surface 17 of the module, and forward and rearward relative to the centre line 12 of the module in conveying direction.

The conveying surface 17 on the top side of the body part 3 of the modules 1 has a substantially flat configuration and is of closed design. The bottom side 23 of the body part 3, viewed transversely to the conveying direction, has a substantially belly-shaped configuration.

The conveying surface 17 links up, in a substantially flat manner, with the closing surfaces formed by back parts 21 of the hinge loops 6. Consequently, when the successive modules 1 are situated in a flat plane, their conveying surfaces 17 form a closed conveying surface.

In FIGS. 2 and 6 it is clearly visible that the bottom side 23 of the body part is reduced adjacent the side edge, at least at the location of an intermediate space 7 situated between the hinge loops 9. Between the inner driving faces 13A, further, a free space 18 is present. This free space enhances the cleanability of the bottom side of the module.

In FIG. 7, a first type of drive wheel 15 is shown, of which a tooth 24 cooperates with an outer driving face 14A of the module 1. In this exemplary embodiment, this drive wheel has six teeth 24, uniformly distributed along the circumference. The teeth 24 can be received between side surfaces 25 of two adjoining hinge loops 6 of a successive module 1. The teeth 24 each have a driving flank 24A and are for driving in one conveying direction. The sprocket wheel 15 can also be provided with an equally great set of mirrored teeth, staggered transversely to the conveying direction, for driving in the opposite direction. It is clearly visible in the Figure that the reduced intermediate space 7 renders the outer driving face 14A well accessible to the tooth 24, and that as a result, the outer driving face 14A, when running, can be cleaned well from the conveying surface 17.

In FIG. 8, a second type of drive wheel 16 is shown which cooperates with the inner driving faces 13A of the module 1. In contrast with the first type of drive wheel, of which the width of the teeth 16 corresponds, transversely to the conveying direction, to the width of the outer driving face 14A, the width of the teeth 26 of this second type of drive wheel 16 corresponds to the width of a plural number of inner driving faces 13A. The second type of sprocket wheel 16 can, for instance, be a sprocket wheel borne by the jacket of a drum motor and having a relatively large diameter, and provided with, for instance, twelve teeth. This Figure clearly shows that the free space 18 can also be utilized for receiving a relatively large tooth 26. Such a tooth can be provided on both sides with driving flanks 27A, B for driving in two opposite directions.

At least a part of the hinge loops 6 is provided with a groove 28, extending in conveying direction P, reaching into the hinge hole 6. This groove extends from the bottom side 27 of the hinge loop 6 in the direction of the conveying surface 17, to a point spaced away from the conveying surface. In this exemplary embodiment, the groove 28 extends as far as the bottom side 23 of the body part 3.

It will be clear that the invention is not limited to the exemplary embodiments represented here. For instance, the body part of the module can be of, at least partly, open design such as, for instance, a so-called flush grid mat module, and/or it may have a twisted, wave, zigzag, grid or spine-shape. The conveying surface can further be of not-flat design, for instance hollow, spherical and/or ribbed. Such variants will be clear to the skilled person and are understood to fall within the range of the invention as represented in the following claims.

1. A module for a conveyor mat, comprising a body part which is provided, on front and rear sides extending transversely to a conveying direction, with staggered rows of hinge loops, spaced apart by intermediate spaces, transversely to the conveying direction, with hinge holes extending transversely to the conveying direction in a manner such that front and rear sides of successive modules can be coupled with the aid of a hinge pin which extends transversely to the conveying direction, with the hinge loops interlocking, which hinge loops extend between, on the one side, outer faces situated on the front or rear side of the module and, on the other side, inner faces situated closer to the middle of the module, wherein the outer faces are situated closer to the hinge holes than the inner faces, the outer faces being provided with outer driving faces for cooperation with teeth of a drive wheel of a first type, and the inner faces being provided with inner driving faces for cooperation with the teeth of a drive wheel of another type.

2. A module according to claim 1, wherein the inner or outer driving faces have a substantially curved configuration.

3. A module according to claim 2, wherein the driving faces are curved with substantially constant radius of curvature relative to an axis of curvature extending substantially transversely to the conveying direction.

4. A module according to claim 1, wherein the curvature of the outer driving faces is stronger than the curvature of the inner driving faces.

5. A module according to claim 3, wherein the radius of curvature of the outer driving faces is greater than the radius of curvature of the inner driving faces.

6. A module according to claim 1, wherein the body part is substantially sheet-shaped.

7. A module according to claim 6, wherein the hinge loops extend substantially outward and downward relative to a conveying surface of the body part.

8. A module according to claim 1, wherein the module is provided with a conveying surface which is substantially closed.

9. A module according to claim 1, wherein the conveying surface of the module links up in a substantially flat manner with closing faces formed by back parts of the hinge loops.

10. A module according to claim 1, wherein between the inner driving faces at the bottom side of the module a free space is present.

11. A module according to claim 1, wherein the body part is provided, at the location of an intermediate space between the hinge loops, with a reduced portion tapered towards a conveying surface of the module.

12. A module according to claim 1, wherein the bottom side of the body part transversely to the conveying surface has a substantially belly-shaped configuration.

13. A module according to claim 1, wherein at least a part of the hinge loops is provided with a groove extending in conveying direction, which reaches into the hinge hole.

14. A module according to claim 13, wherein the groove extends from the bottom side of the hinge loop in the direction of the conveying surface to a point at a distance from a conveying surface of the module.

15. A modular conveyor mat, comprising a number of modules successive in conveying direction, each provided with a body part extending transversely to the conveying direction, having hinge loops reaching forward and backward in conveying direction, the hinge loops of successive modules cooperating and being coupled with the aid of hinge pins, while at least two successive modules are designed according to claim 1.

16. A modular conveyor mat according to claim 15, wherein the conveyor mat can be driven, at wish, by a first type of drive wheel, the width of the teeth of which corresponding to the width of an outer driving face, or with a different type of drive wheel, the width of the teeth of which corresponding to the width of a plural number of inner driving faces.
